(19) United States
(12) Patent Application Publication
(10) Pub. No.: US 2025/0335578 A1
(43) Pub. Date: Oct. 30, 2025

(54) MULTI-CHIPLET TRUSTED EXECUTION ENVIRONMENT (TEE)

(71) Applicant: Openchip & Software Technologies S.L., Barcelona (ES)

(72) Inventors: Francesc Guim Bernat, Barcelona (ES); Violante Moschiano, Avezzano (IT); Edgar Gonzalez Pellicer, Girona (ES); Gaspar Mora Porta, Castellon de la Plana (ES); Tommaso Vali, Sezze (IT); Satoru Tagaya, Barcelona (ES); Erich Ludwig Focht, Stuttgart (DE)

(21) Appl. No.: 19/262,979

(22) Filed: Jul. 8, 2025

Related U.S. Application Data
(63) Continuation of application No. PCT/EP2025/054425, filed on Feb. 19, 2025.

(51) Int. Cl. G06F 21/53; G06F 21/44; G06F 21/60

(52) U.S. Cl. CPC G06F 21/53; G06F 21/44; G06F 21/602

(57) ABSTRACT

Aspects of a multi-chiplet trusted execution environment (TEE) in a multi-chiplet architecture are described. A first chiplet receives a signal indicating creation of a TEE domain at a second chiplet in response to a process executed on the second chiplet. An identifier for the TEE domain is obtained based on the signal. Subsequently, a request associated with the TEE domain is received and verified using the obtained identifier. Upon successful verification, the request is executed. This approach enables secure communication, authentication, or execution of processes across multiple chiplets, thereby enhancing the overall integrity and trustworthiness of the chiplet-based system.

### PRIORITY

This application is a continuation of International Application No. PCT/EP2025/054425, filed Feb. 19, 2025, which is incorporated herein by reference in its entirety.

### STATEMENT OF FUNDING

This invention was made with government support under Grant UNICO-IPCEI-2023-001 funded by the European Union-Next Generation EU, Important Projects of Common European Interest (IPCEI).

### BACKGROUND

A secure enclave (e.g., trusted hardware, trusted execution, etc.) is typically a hardware-supported, protected area within a processor that is designed to securely store and process sensitive information. By leveraging cryptographic mechanisms at the hardware level, a secure enclave isolates confidential code or data from both the operating system and potential malicious agents. This approach can maintain the integrity of essential processes—such as license management, digital asset protection, and user authentication—and can ensure that even if the primary system is compromised, critical computations remain secure. The hardware-based authentication within a secure enclave can support trusted attestations or simplifies compliance with strict security standards.

A Trusted Execution Environment (TEE) is a secure enclave generally located within a main processor of a device. The TEE operates to isolate code or data to ensure confidentiality or integrity of sensitive computations. By leveraging hardware-backed security mechanisms, the TEE can generally attest to the authenticity of software components, preventing unauthorized manipulation or tampering of software. This approach can dimmish the overall attack surface of a system or device. A TEE can also enable critical applications—such as mobile payment services, digital rights management, and secure key management—to execute in a protected context, significantly reducing exposure to malware or other threats. In an example, a TEE can facilitate secure provisioning of cryptographic keys or enable hardware-based attestation, enhancing trust in distributed systems.

### BRIEF DESCRIPTION OF THE DRAWINGS

In the drawings, which are not necessarily drawn to scale, reference numerals are repeated to describe similar components in different views. Like numerals having different letter suffixes may represent different instances of similar components. The drawings illustrate generally, by way of example, but not by way of limitation, various embodiments discussed in the present document.

FIG. 1 depicts a chiplet system implementing a multi-chiplet TEE, according to an embodiment.

FIG. 2 depicts a chiplet architecture for a multi-chiplet TEE, according to an embodiment.

FIG. 3 depicts TEE support in a chiplet for a multi-chiplet TEE, according to an embodiment.

FIG. 4 depicts component messaging, according to an embodiment.

FIG. 5 depicts a method for a multi-chiplet TEE, according to an embodiment.

FIG. 6 depicts a hardware arrangement of a data center used to provide multiple implementations or instances of a computing system, according to an example.

FIGS. 7A and 7B depict arrangements of a chip assembly with expanded views of the chiplets and processing units, according to an example.

FIG. 8 depicts a block diagram of a computing system, according to an example.

### DETAILED DESCRIPTION

As the demand for computing resources continues to increase, specialized hardware-based computing using accelerators—such as Artificial Intelligence (AI) accelerators—has emerged as a mechanism for speeding up several critical operations. These operations can include AI workloads executed by AI accelerators, data transfer operations managed by specialized Direct Memory Access (DMA) engines (e.g., a data streaming accelerator), or graphics processing facilitated by Graphics Processing Units (GPUs). These specialized accelerators operate in conjunction with existing Central Processing Units (CPUs) or other primary processors to improve performance. Often, tasks are executed collaboratively, such as in many machine learning data pipelines in which data operations are jointly performed by CPUs and GPUs or other accelerators.

Modern workloads often expect (e.g., require) secure enclaves. These enclaves establish trusted domains within a network of machines (e.g., in the cloud) and are particularly notable for their ability to carve out isolated, protected environments even in virtualized settings. However, there exists an issue in maintaining a secure enclave across elements within a single machine or platform (e.g., in a system-on-chip (SoC) or the like). Generally, once a workload (e.g., application) employs multiple accelerators in a pipeline model, the traditional techniques to implement a secure enclave in the context of compute elements tend to fail because these additional computing elements cannot enforce the exclusivity of execution and data used to maintain the secure enclave. In the context where different accelerators are working together—for example connected with a local or remote input-output (I/O) Hub or different interposers or optical connections—challenges exist in defining secure domains when configuration of the topology can change.

To address these issues, architecture and techniques to implement a multi-chiplet TEE are described herein. These features enable inclusion of on-chip accelerators within trusted domains (e.g., for VMs) by defining resources within a component (e.g., an accelerators) as part of a TEE via spatial or temporal slicing. Thus, the components (e.g., accelerators or parts of accelerators) within the TEE can grow or shrink, over time, as defined by an inter-component definition procedure. This can be accomplished by including, in each TEE capable component, TEE circuitry configured to advertise TEE availability, and accept specifics (e.g., encryption keys) for a TEE domain via an inter-component signaling mechanism.

Thus, an orchestrating device, such as a CPU, can establish a TEE domain and expand the elements within the TEE domain by sharing the domain specifics with other computing elements in within a computing device, such as chiplet-based processors, System-on-chip (SoC) circuitry, System-in-Package (SiP) or System-on-Package (SoP) circuitry, and other modular packaging implementations of processor circuitry. Additional details and examples are provided below.

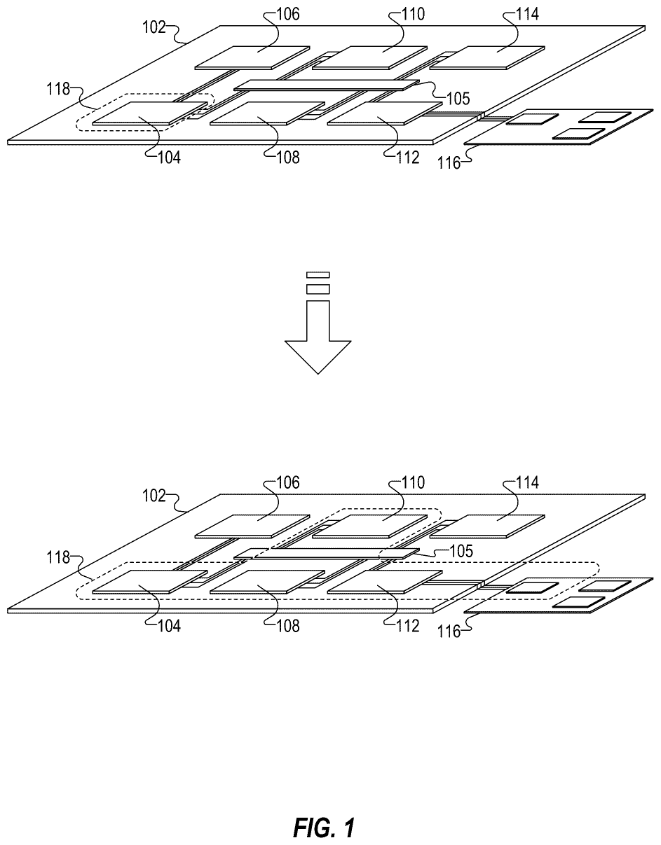

FIG. 1 depicts a chiplet system implementing a multi-chiplet TEE, according to an embodiment. As illustrated, the chiplet system can include a chiplet package 102 (e.g., an SoC, SiP, or SoP) that includes a compute tile 104, memory 106 (e.g., random access memory (RAM)), a data movement accelerator 108, a media or AI accelerator 110, sensor processor 114, and an off-package interface 112 (e.g., a compute express link (CXL) interface). As illustrated, the compute tile 104 is directly connected to the memory 106—such as via a double data rate (DDR) memory interface, a High Bandwidth Memory (HBM) interface, Universal Memory Interface (UMI), or Bunch of Wires (BoW) interface, etc.—the off-package interface 112 is connected to an external component 116, such as a network interface, and the remaining components communicate via an input-output (IO) hub 105 (e.g., operating in accordance with a Universal Chiplet Interconnect Express (UCIe) family of standards) the chiplet package 102.

The compute tile 104 includes hardware to implement a TEE domain 118, and thus the compute tile 104 can be considered an orchestrating component for implementing the multi-chiplet TEE. Between the top image and the bottom image, the TEE domain 118 is expanded to include additional components, such as the data movement accelerator 108, the media or AI accelerator 110, the off-package interface 112, and a sub-component of the external component 116. This expansion is accomplished by the transmission, from the compute tile 104 (e.g., TEE circuitry of the compute tile 104) a TEE domain identifier to, for example, TEE circuitry of the media or AI accelerator 110. This TEE domain identifier is then used by the receiving TEE circuitry to establish TEE operating conditions (e.g., cryptographic keys, attestation information, etc.) such that TEE workloads can be executed on the receiving component (e.g., the media or AI accelerator 110 or the data movement accelerator 108).

The following examples illustrate the procedure from the perspective of the additional component, and more specifically from processing circuitry of that component implementing TEE domain activities on the component. Accordingly, the processing circuitry of a first chiplet (e.g., the media and AI accelerator 110) is configured to receive (e.g., via the IO hub 105) a signal indicating creation of the TEE domain 118 at a second chiplet (e.g., the compute tile 104). As noted above, the creation of the TEE domain 118 is based on a process of the second chiplet 104. That is, the second chiplet establishes the TEE domain 118 for whatever reason-such as a request from software, a configuration of an operating system, workload security rules, etc.-and notifies the first chiplet of inclusion into the TEE domain 118 via the signal. In an example, traffic (e.g., inter-chiplet communications) is encrypted, for example, over the IO hub 105 or the off-package interface 112) to secure the traffic at the communication layer. The encryption can be based on (e.g., use) the same key employed by the TEE circuitry to ensure security of the process within a given chiplet.

The processing circuitry is configured to obtain (e.g., retrieve, receive, create, etc.) an identifier of the TEE domain based on the signal. The signal can include a simple message provoking the first chiplet to contact a facility (e.g., another chiplet, and external component, etc.) to retrieve the identifier. In an example, the signal can include a component from which the identifier can be determined (e.g., a seed applied to a built-in cryptographic technique to generate a key). In an example, the signal can include the identifier in its entirety. For example, the signal can include a base-memory address to indicate the start of a virtualized memory space for a process. Here, the identifier is the base memory address of the process on the second chiplet.

As noted above, the signal can provoke the first chiplet into requesting the identifier. Accordingly, in an example, to obtain the identifier, the processing circuitry is configured to make (e.g., transmit, cause to be transmitted, invoke, trigger, etc.) a request for the identifier of the second chiplet in response to the signal. Here, the identifier is received as a response to the request. For example, the compute tile 104 sends the signal to the media or AI accelerator 108. The TEE circuitry in the media or AI accelerator 108 responds to the signal with a TEE domain key request from the compute tile 104, and the compute tile 104 again responds with the TEE domain key. Many TEE identifiers are cryptographic elements, such as encryption keys, and are used by the TEE circuitry to, for example, encrypt and decrypt instructions or data on-the-fly to ensure the security of the TEE domain 118. Accordingly, in an example, the identifier is a cryptographic element used to ensure execution isolation in a TEE of the second chiplet. In an example, the cryptographic element is a signature. In an example, the cryptographic element is a decryption key. In an example, the decryption key is a symmetric key.

Once the identifier is obtained by the processing circuitry of the first chiplet, the first chiplet is capable of operating within the TEE domain 118. This is realized, when for example, the processing circuitry of the first chiplet receives a request for the TEE domain 118. For example, if the compute tile 104 is executing a program with a graphical output that can be accelerated with a single-instruction-multiple-data (SIMD) processing pipeline, such as is common with GPU acceleration. The compute tile 104 can push these operations to the media or AI accelerator 108 using, for example, an encryption based on the identifier. When the request to compute the raster output is received by the media or AI accelerator 108, the TEE processing circuitry of the media or AI accelerator 108 can decrypt the request and access data or parameters to execute the request.

The processing circuitry of the first chiplet is configured to verify the request based on the identifier prior to execution. In an example, verifying the request based on the identifier includes using a Resource Arbitration Login (RAL) component of the first chiplet. The RAL is generally a component that addresses race conditions, or other resource conflict issues, that can arise in the first chiplet. However, because the RAL mediates access to resources, the RAL provides a convenient implementation point in the first chiplet to enable or disable access based on the TEE domain 118. Thus, the request can be tagged with, for example, a valid memory range that corresponds to the TEE domain 118, and thus verified by the RAL. In an example, the processing circuitry is configured to write a RAL local identifier to the RAL based on the identifier. Here, a RAL specific access identifier is assigned to the TEE domain 118 based on the original TEE domain identifier. The RAL specific identifier can include, for example, an instruction address range specific to the TEE domain 118 that is carried or assigned to the request when it arrives at the first chiplet. In an example, the processing circuitry of the first chiplet is configured to detect the identifier in the request and also configured to verify the identifier in the request using the RAL local identifier.

In an example, verifying the request based on the identifier includes using a Trust Provisioning Agent (TPA) component of the first chiplet. The TPA is generally a more full-featured TEE component, providing, for example, encryption-decryption facilities, secure registers, attestation components, etc. In an example, the processing circuitry is configured to write a TPA local identifier to the TPA based on the identifier to create a TPA local identifier. In an example, the processing circuitry is configured to detecting the identifier in the request and verifying the identifier in the request using the TPA local identifier.

In an example, where the identifier is a base memory address of the process on the second chiplet, verifying the request based on the identifier includes using a Memory Management Unit (MMU) component of the first chiplet. In an example, the processing circuitry is configured to write the base memory address to the MMU for the process.

Once the TEE domain request has been successfully verified, the first chiplet is configured to execute the request. In examples where the identifier is functional, such as when the identifier is a cryptographic key, the verification can includes using the key to successfully decode the request or a portion of the request (e.g., the data or instruction in the request). In examples where the identifier is a label, then successful verification involves matching the label to the locally stored version of the label.

In an example, executing the request includes using a set of components of the first chiplet. These components could be memory, accelerator circuitry, or other discrete elements of the first chiplet. In an example, the set of components are defined by the second chiplet. Here, the second chiplet (e.g., the orchestrating chiplet) is defining what elements are part of the TEE domain 118. Thus, the second chiplet determines whether a shader is an included valid component in a GPU chiplet, for example. In an example, the set of components are defined based on time. This example enables time slicing of components for TEE domain inclusion. Thus, the memory 106 could be part of the TEE domain 118 during a certain window of time and not part of the TEE domain 118 at other times.

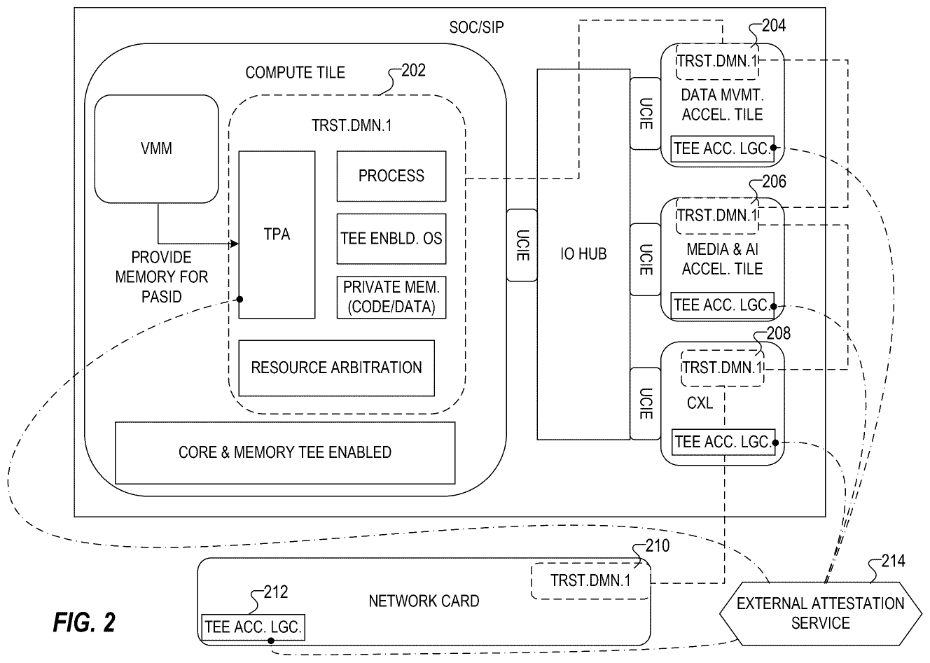

Dynamically enabling inclusion into the TEE domain 118 further enables future chiplet integrations that can also be dynamic. For example, future chiplets could be optically connected to other I/O Hubs, enabling the dynamic creation of systems where new chiplets can be made available at runtime. In an example, the TEE circuitry (e.g., a TPA) can be configured to perform attestation of chiplets, including chiplets being added to the TEE domain 118. Attestation is a procedure in which the TPA can establish that a target chiplet is the expected chiplet (e.g., the correct type, working correctly, unmodified with malicious code, etc.) and thus will function as expected if added to the TEE domain 118. Attestation often involves querying the target chiplet and comparing response against known values for the responses to determine whether they match. These known results can be obtained, or the entire attestation verified, by an external entity (e.g., the external attestation entity 212 illustrated in FIG. 2). By using attestation, the TEE circuitry can ensure the integrity of the TEE domain 118 even with dynamically added chiplets. Accordingly, in an example, the TEE circuitry of the first chiplet is configured to receive an attestation query from the second chiplet and to respond to the attestation query with an attestation metric of the first chiplet. In an example, the second chiplet provides the attestation metric received from the first chiplet to an external attestation entity to verify the second chiplet.

In an example, the first chiplet prevents operations from other domains on the set of components. Thus, if another TEE domain than the TEE domain 118, or a non-TEE process attempt to use the set of components, the first chiplet prevents the process from using these components. In an example, the set of components include a memory device, an accelerator, a processor, or an interface. These examples help to ensure security for TEE domain workloads by preventing other workloads from running on the same hardware when the component is in the TEE domain 118.

FIG. 2 depicts a chiplet architecture for a multi-chiplet TEE, according to an embodiment. As illustrated, the chiplet package (e.g., SoC, SiP, etc.) includes a compute tile and a number of other components, including data movement accelerator, media or AI accelerator, and external interface chiplets and an external network card. Each of these components includes TEE accelerator circuitry-such as TEE accelerator circuitry 212 in the network card-to interact with other TEE elements and establish the trust domain across components. In operation, the trust domain 202 is established in the compute tile and signaled to the other components to create the trust domain 204 in the data movement accelerator tile, the trust domain 206 in the media or AI accelerator tile, the trust domain 208 in the external interface tile, and the trust domain 210 in the network card. These trust domains operate similarly such that the sharing of TEE parameters (such as a cryptographic key) enables the TEE accelerator circuitry in each component to execute a workload as if the workload were executing on the compute tile.

The illustrated architecture is an expansion to TEE circuitry distribution between components when compared to other arrangements that enable TEE domain use of on-die accelerators as part of trustable resources. Part of this expansion is the local facility in accelerators to map requests or corresponding data flows (e.g. access to memory) into configurable, and perhaps multiple, TEE domains. Thus, the TEE accelerator circuitry on the components is configured to perform process verification or security to prevent elements outside the TEE domain to access the accelerator data (e.g. registers, memory, cache, etc.). The TEE accelerator circuitry can also be configured to prevent requests for a particular TEE domain workload from using resources allocated to another TEE domain.

As noted in FIG. 1, there are several ways in which the TEE accelerator circuitry of the component can enforce TEE domain integrity. For example, simple transformations can be employed. For example, if a component in TEE domain X attempts to copy a memory range from memory to a network interface card (NIC) memory using a Data Copy Accelerator (DCA), the DCA will verify that the memory in the copy range is allocated to the TEE domain X before performing the copy. In an example, pipeline accelerations can be employed. Here, the data copying operation can be directed through a set of pipelines of accelerators. For example, a DCA copying data from memory and sending it to an AI agent. The AI agent can then perform analytics (e.g., stored in the memory of the TEE domain X) and the NIC agent can encrypt the data provided by the AI agent before storing into memory on the BIC.

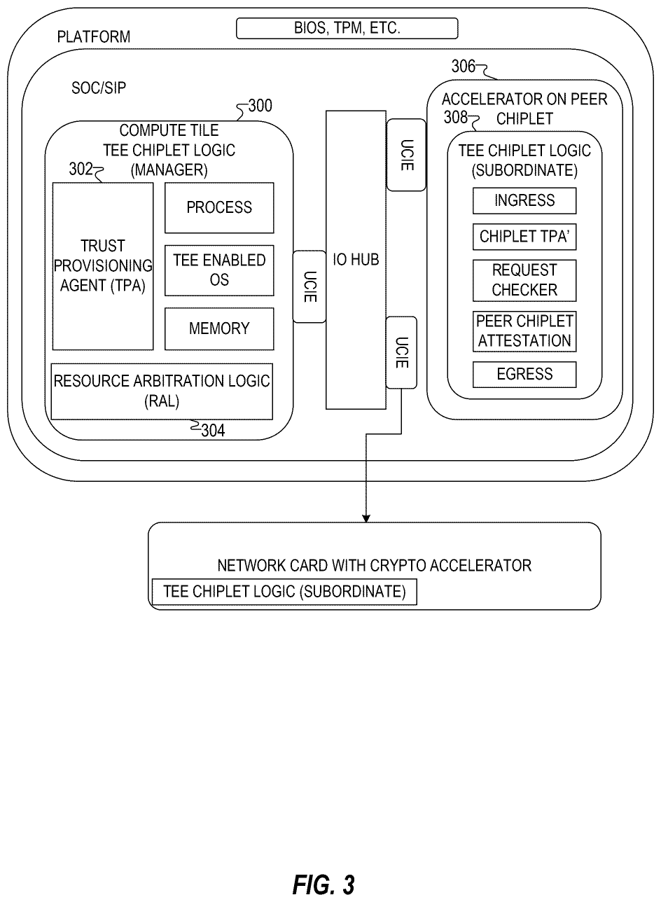

FIG. 3 depicts TEE support in a chiplet for a multi-chiplet TEE, according to an embodiment. The illustrated architecture identifies a couple of elements that are enhanced to support the TEE domain expansion described herein. For example, existing RAL 304 circuitry is modified to enable the identification of TEE domain association of a workload and record to which resources that TEE domain has access. Here, during process arbitration of resources, the RAL 304 can enforce TEE domain workload restrictions for the governed resources.

In an example, the Trust Provisioning Agent TPA circuitry 302 of, for example, a compute tile 300, is modified to enable virtual partitioning (e.g., slicing) of on-tile components into the TEE domain. Further, similar functionality is included in each of the accelerators, such as the TEE circuitry 308 on the peer accelerator 306. The TEE circuitry 308 can be configured to associate resources or tag resources (e.g. queue entries) into particular trusted domains (e.g. identified with a process address ID) or control who access to data or state corresponding to the TEE domain.

The TEE circuitry 308 can be configured to ensure that workloads (e.g., processes, access requests, interrupts, debugging signals, etc.) cannot access resources that belong other trusted domains. As illustrated, the compute tile 300, or another component, operates as a primary component (e.g., director, orchestrator, conductor, etc.) that is responsible for trust establishment and generally spawns the primary process for a given application. From this initial position, the other components (e.g., other chiplets or accelerators) are in a different TEE domain (including no TEE domain) and the primary component coordinates the distribution of TEE domain specifics (e.g., TEE domain IDs, keys, operating ranges, etc.) when, for example, the TEE domain is created for the primary process, to the other components, such as the peer chiplet accelerator 306. There is no requirement that the primary chiplet be the compute tile 300, or any specific chiplet. Rather, which ever chiplet started a TEE domain can operate as the primary for coordinating the expansion of the TEE domain to peer chiplets or other components. In an example, the primary component is configured to perform attestation of a potential peer chiplet upon discovery to ensure that the TEE circuitry 308, or the like, in the peer chiplet provides the expected security to avoid compromising the TEE domain.

As noted earlier, traditional TEE elements (e.g., RAL 304 or TPA 302) that are responsible to arbitrate resources between use can be configured to provide a number of additional functions. For example, TEE elements (e.g., RAL 304 or TPA 302) can be configured to enable access to a particular die accelerator or to a set of resources hosted within a chiplet or another component. Resources may include memory or other elements that can be mapped into a TEE domain. The TEE elements (e.g., RAL 304 or TPA 302) can be configured to allow requests corresponding to a TEE domain being processed at the accelerator 306 to access to other resources for that request. This may include memory regions that are used to store results from the accelerator 306. In an example, the TEE elements (e.g., RAL 304 or TPA 302) are configured to enable (e.g., allow) at least some TEE domain restricted data into the accelerator 306 to perform operations (e.g., a transformation) to complete the request. For example, if there is a need to store some keys to decrypt certain data that is provided as part of the request.

In an example, the TEE circuitry 308 is configured to coordinate with the TEE elements (e.g., RAL 304 or TPA 302). In an example, the TEE circuitry 308 is configured to process requests coming to the accelerator 306—either directly from the compute tile 300 or from another accelerator in a pipeline created by the compute tile 300.

In an example, structures in the accelerator 306—such as ingress, egress, queues, etc.—are configured to be indexed or mapped (e.g., using a table of request ID to a process address space ID (PASID) or TEE domain) to trusted domains. Here, any request or data being processed by the accelerator 306 can be mapped at any time to a corresponding TEE domain ID, for example. In an example, the TEE circuitry 308 is configured to manage requests coming from the TEE elements (e.g., the RAL 304 or the TPA 302) to associate specific resources into the TEE domain or to, for example, notify internal components that a TEE domain will start sending requests, for example, directly or through a pipeline for the accelerator 306. Generally, the request checker is configured to ensure that a request being processed in the accelerator 306 and belonging a TEE domain has access to the requested resources. The request checker can also be configured to ensure that entities (e.g., devices, workloads, processes, etc.) outside the TEE domain cannot access the resources or data generated from requests belonging (e.g., have TEE parameters for the TEE domain) to the TEE domain.

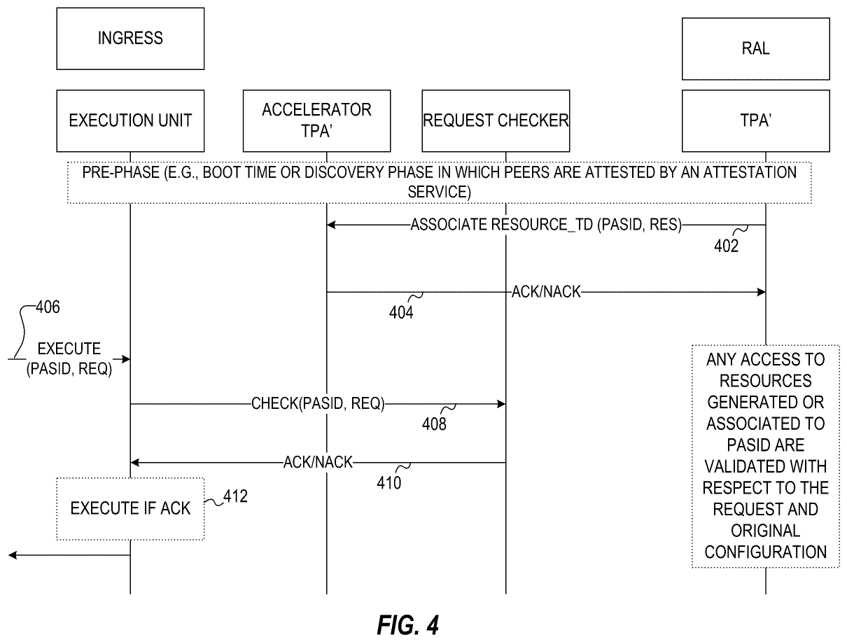

FIG. 4 depicts component messaging, according to an embodiment. After a peer chiplet passes attestation (e.g., verification), the primary component can associate a TEE domain ID (e.g., a PASID) to the TEE circuitry on the peer chiplet (operation 402). The peer chiplet TEE circuitry can respond with a NACK and not participate in the TEE domain or can respond with an ACK to become included in the TEE domain (operation 404). Once the ACK is received, the primary component can validate TEE domain requests and forward onto the peer chiplet.

When the peer chiplet receives a TEE domain workload (operation 406), the TEE circuitry of the peer chiplet verifies the TEE domain ID (operation 408). If the verification response (operation 410) passes, then the peer chiplet executes the TEE domain workload (operation 412).

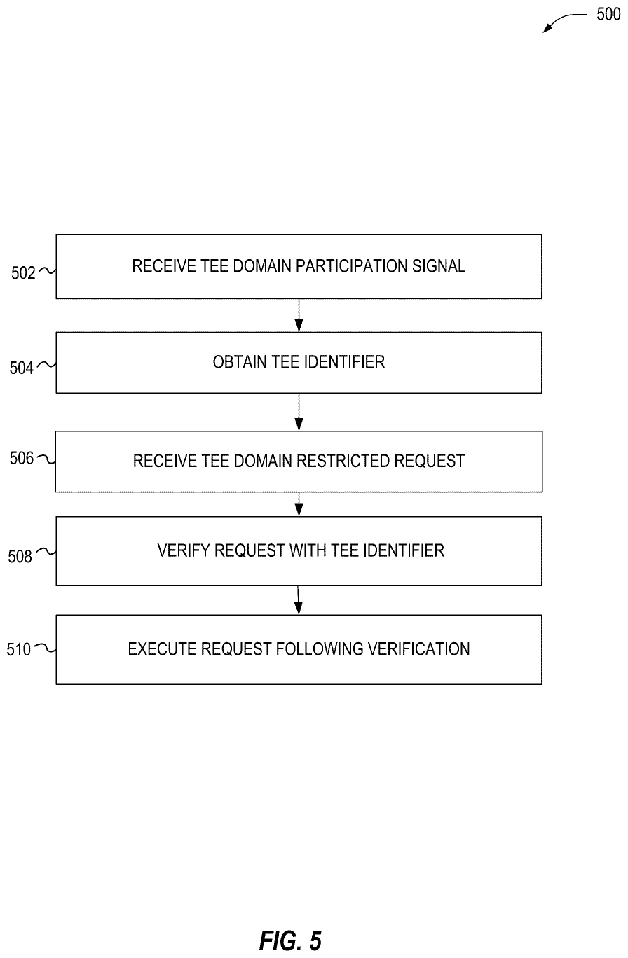

FIG. 5 depicts a method 500 for a multi-chiplet TEE, according to an embodiment. The operations of the method 500 are implemented in computer hardware, such as that described above or below (e.g., processing circuitry).

At operation 502, a signal indicating creation of a TEE domain at a second chiplet is received at processing circuitry of a first chiplet in a chiplet system. Here, the creation of the TEE domain is based on a process of the second chiplet.

At operation 504, an identifier of the TEE domain is obtained based on the signal. In an example, the identifier is a base memory address of the process on the second chiplet.

In an example, obtaining the identifier includes making a request for the identifier of the second chiplet in response to the signal, and receiving the identifier as a response to the request. In an example, the identifier is a cryptographic element used to ensure execution isolation in a TEE of the second chiplet. In an example, the cryptographic element is a signature. In an example, the cryptographic element is a decryption key. In an example, the decryption key is a symmetric key.

At operation 506, a request for the TEE domain is received.

At operation 508, the request is verified based on the identifier. In an example, verifying the request based on the identifier includes using a Resource Arbitration Login (RAL) component of the first chiplet. In an example, wherein the method 500 includes the operation of writing a RAL local identifier to the RAL based on the identifier in response to obtaining the identifier to create a RAL local identifier. In an example, wherein the method 500 includes the operations of detecting the identifier in the request, and verifying the identifier in the request using the RAL local identifier.

In an example, verifying the request based on the identifier includes using a Trust Provisioning Agent (TPA) component of the first chiplet. In an example, the method 500 includes the operation of writing a TPA local identifier to the TPA based on the identifier in response to obtaining the identifier to create a TPA local identifier. In an example, the method 500 includes the operations of detecting the identifier in the request, and verifying the identifier in the request using the TPA local identifier.

In an example, where the identifier is a base memory address of the process on the second chiplet, verifying the request based on the identifier includes using a Memory Management Unit (MMU) component of the first chiplet. In an example, the method 500 includes the operation of writing the base memory address to the MMU for the process.

At operation 510, the request is executed based on a successful verification of the request. In an example, executing the request includes using a set of components of the first chiplet. In an example, the set of components are defined by the second chiplet. In an example, the set of components are defined based on time. In an example, the first chiplet prevents operations from other domains on the set of components. In an example, the set of components include a memory device, an accelerator, a processor, or an interface.

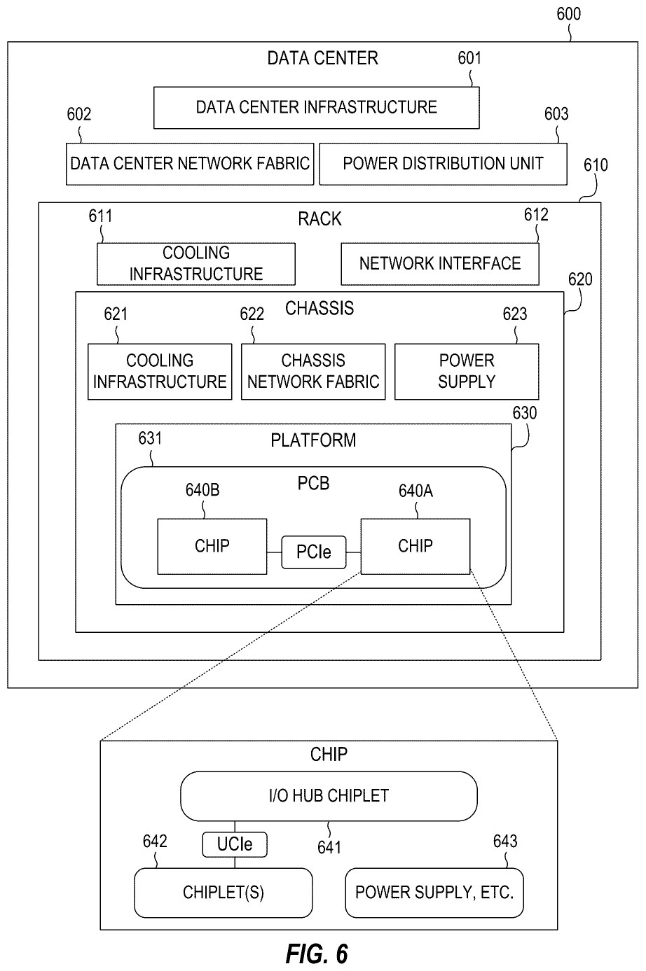

FIGS. 6, 7A, 7B, and 8 respectively depict simplified aspects of example computing architectures in which any of the techniques and configurations above may be implemented. It will be understood that the elements described above for multi-chiplet TEE may be integrated into various forms of the following hardware components.

FIG. 6 depicts an example hardware arrangement of a data center 600 used to provide multiple implementations or instances of a computing system (e.g., computing system 800, discussed below), with each instance of the computing system being identified as a respective platform (e.g., platform 630). The data center 600 includes data center infrastructure 601, a data center network fabric 602, and a power distribution unit 603 to support multiple racks of compute platforms, with a single instance of a rack 610 depicted. The data center infrastructure 601 may provide physical components that host the compute platform hardware, storage components, and networking equipment; the data center network fabric 602 may include switches and networking components to support data flows among various compute platforms and storage devices throughout the data center; and the power distribution unit 603 may include components to distribute and control power among the various compute platforms, networking, and storage devices.

The rack 610 includes but is not limited to cooling infrastructure 611, a network interface 612, and related physical components (not shown) to support discrete instances of multiple chassis. The rack 610 provides power, connectivity, and cooling to each of the multiple chassis in a single rack, with a single instance of a chassis 620 depicted in FIG. 6. The chassis 620 includes but is not limited to cooling infrastructure 621, a chassis network fabric 622, and a power supply 623, which provides cooling, network connectivity, and power to multiple platforms within the chassis, with a single instance of a platform 630 depicted in FIG. 6. It will be understood that a common data center rack configuration may include dozens of chassis, with each chassis adapted to support a number of platforms depending on the physical size of the platform hardware and supporting equipment.

The platform 630 in some implementations may be referred to as a server or node, depending on the use case for the platform 630 and the data center 600. The platform 630 includes but is not limited to implementations of a discrete computing system hosted on a single board. The platform 630 is depicted as hosting a chip assembly 640A and chip assembly 640B on a first board provided by a printed circuitry board (PCB) or other platform board, shown as PCB 631. In some examples, the platform 630 may include only one chip package, whereas the PCB 631 depicts interconnection of multiple chip assemblies via a device-to-device interface (e.g., a PCI express (PCIe) or compute express link (CXL) interface). Additional chip packages and components (not shown) may also be hosted on the PCB 631.

Some implementations of the chip assembly 640A and 640B may be termed as a System-on-Chip (SoC) package, as modular chiplets that perform different functions are integrated into a single package-even though this chip package is composed of multiple dies unlike a traditional SoC design that uses a single die. Other implementations of the chip assembly 640A and 640B may be termed as a System-on-Package (SoP), System-in-a-Package (SiP), or similar references to a single chip package. Various combinations of 2D, 2.5D, and 3D packaging technologies may be used to manufacture and assemble the chip package and its underlying structure, and different manufacturing processes may be used to provide chiplets and components from different process nodes (e.g., semiconductor fabrication systems).

The chip assembly 640A and chip assembly 640B are each packages that include multiple chiplets or dies for respective functions, such as separate chiplets for processing (e.g., CPU or GPU chiplets), memory (e.g., cache or high-bandwidth memory chiplets), I/O (e.g., I/O chiplets), acceleration (e.g., AI/ML acceleration chiplets), signal processing (e.g., audio or video processing chiplets), and the like. A close-up of chip assembly 640A is depicted as including a I/O Hub chiplet 641, chiplets 642, and a power supply 643. These components may be hosted on an interposer that is designed to connect multiple dies or components within a single semiconductor package (e.g., chip package). In some examples, the chiplets 642 may be manufactured and sourced separately and later assembled into the chip package to create the chip assembly 640A. Various connections may be provided among the chiplets 642 such as with the use of Universal Chiplet Interconnect Express (UCIe) or similar chiplet-to-chiplet interfaces and interconnects (e.g. Advanced Interface Bus (AIB), Bunch of Wires (BoW), etc.), or between chiplets and on-chip memory (e.g., high-bandwidth memory (HBM)) using HBM3 (JEDEC), Universal Memory Interface (UMI), or other memory interfaces. Similar interfaces and interconnects may be used for chip-to-chip or die-to-die communications (e.g., using NVIDIA® NVLink-C2C, Cache Coherent Interconnect for Accelerators (CIX), Compute Express Link (CXL), Advanced extensible Interface (AXI), and certain implementations of PCIe, CXL, etc.).

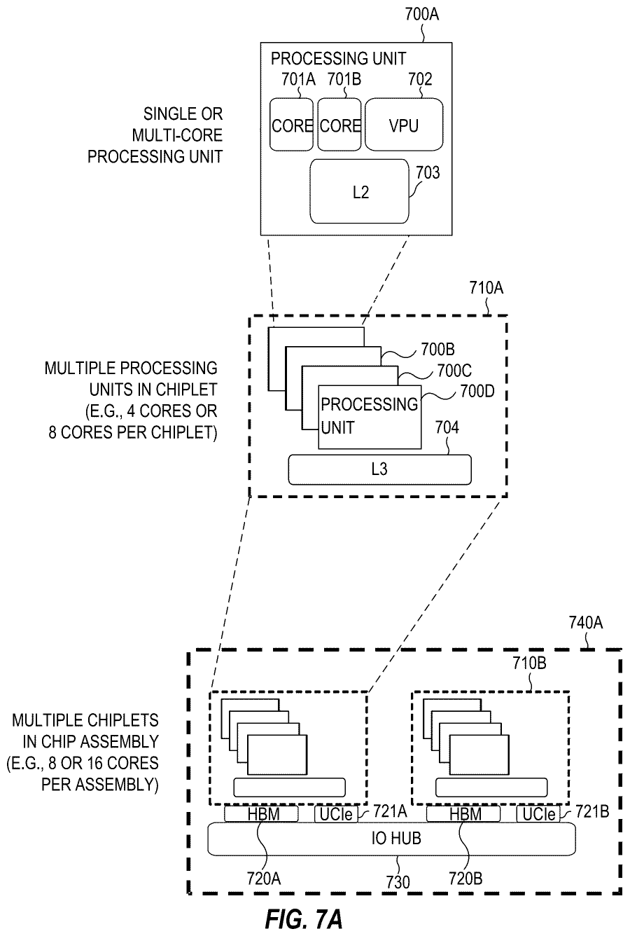

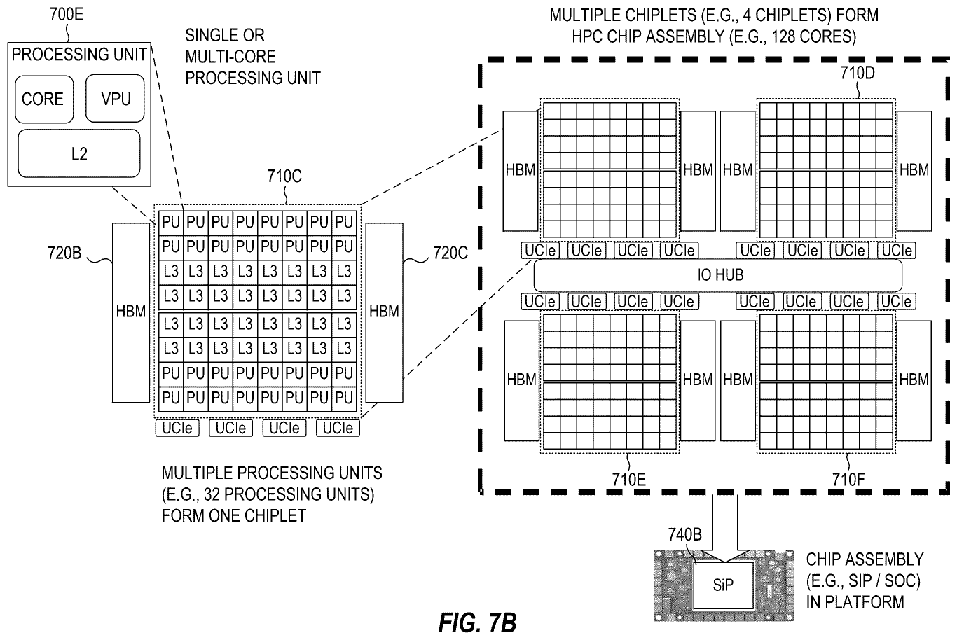

FIG. 7A depicts an example arrangement of a chip assembly 740A (e.g., a multi-processing core implementation of chip assembly 640A or 640B), with expanded views of the chiplets and processing units included therein. This arrangement shows how the chip assembly 740A, which may constitute a SoC, SoP, SiP, or other type of chip package, is composed from chiplets such as chiplet 710A, chiplet 710B, etc. and associated on-package memory (e.g., high-speed memory) such as 3D-stacked, HBM instances shown as HBM 720A, HBM 720B, interfaces (e.g., UCIe interfaces) shown as UCIe 721A, UCIe 721B, and I/O hub 730 (e.g., which may be implemented by a I/O chiplet). Other hardware elements of a chip package are not depicted for simplicity.

Each chiplet includes multiple processing units and each processing unit includes one or multiple cores. For instance, chiplet 710A as depicted includes four processing units (processing unit 700A, processing unit 700B, processing unit 700C, and processing unit 700D) and an L3 cache 704. Each processing unit may include one or multiple processing cores, one or multiple caches, and optionally other processing units or elements. For instance, processing unit 700A is depicted as including two cores (core 701A and core 701B), vector processing unit 702, and an L2 cache 703. Accordingly, a single-core processing unit arrangement can provide 4 cores per chiplet and 8 total cores in a two-chiplet chip assembly, whereas a dual-core processing unit arrangement can provide 8 cores per chiplet and 16 total cores in a two-chiplet chip assembly. Other permutations may also be provided. A variety of signaling interfaces and protocols (not shown) may be used for core-to-core and inter-processor communications, including but not limited to the use of coherency protocols, mesh, ring, or hybrid ring-mesh interconnects, Network-on-Chip (NoC) and packet switched communications, and the like.

FIG. 7B depicts an example arrangement of a chip assembly 740B (e.g., a multi-chiplet high-performance computing (HPC) implementation of chip assembly 640A, 640B), adapted for HPC applications (e.g., parallel processing operations involving thousands, millions, or more of processors or cores operating simultaneously). The example chip assembly 740B depicts placement as a SiP, SoC, or other package onto a platform board (e.g., PCB 631), and optionally in a data center (e.g., data center 600) or in a standalone deployment setting (e.g., in a standalone computer system, mobile computing device, autonomous device, etc.).

The chip assembly 740B is composed of multiple chiplets, shown with four chiplets, chiplet 710C, chiplet 710D, chiplet 710E, chiplet 710F. Each chiplet includes multiple processing units, such as 32 processing units with a corresponding L3 cache for each processing unit. Each processing unit may include one or multiple cores, such as a single-core processing unit 700E shown as part of chiplet 710C. The chip assembly 740B is also composed of corresponding memory resources, such as HBM elements corresponding to respective banks of processing units (e.g., HBM 720B and HBM 720C corresponding respective sets of processing units of chiplet 710C), UCIe interfaces, and an IO Hub.

The chip assembly and related products or devices described herein may be configured in a variety of computing system implementations. Such implementations include machine-readable non-transitory media storing machine-readable instructions and one or more processors coupled to the memory, such that executing the machine-readable instructions configure the computing system and implementing hardware (e.g., the processing unit 700, chiplet 710, chip 640, platform 630) to perform steps and operations described above for electronic systems or devices (e.g., to implement a multi-chiplet TEE, etc.). It should be further understood that software including one or more computer-executable instructions that facilitate processing and operations as described above may be distributed, installed, or otherwise provided with networked devices (e.g., servers or cloud computing systems). Alternatively, in some examples, the software may be obtained and loaded (or, re-loaded/upgraded) from one or more servers and/or cloud computing systems, such as software stored on a server for distribution over the Internet, for example.

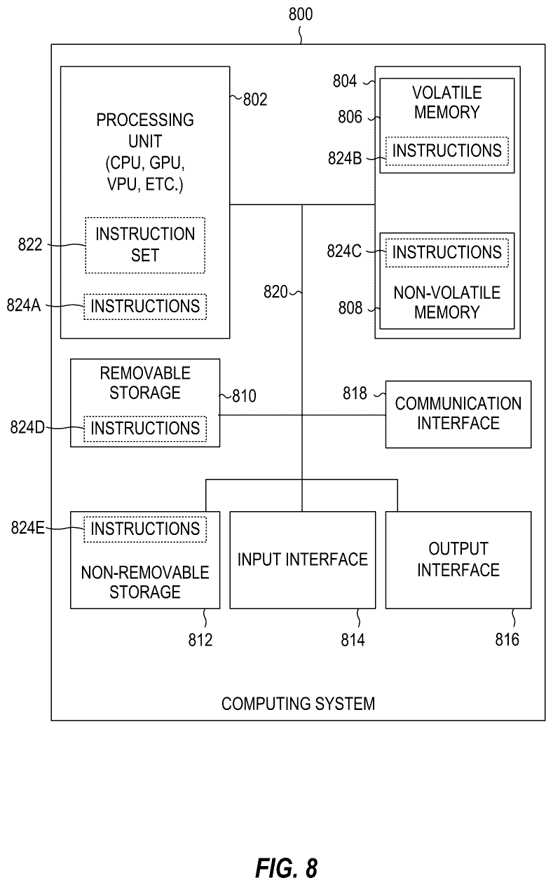

FIG. 8 depicts a block diagram of an example computing system 800 (e.g., device, apparatus, machine, etc.) that may be programmed into a special purpose machine suitable for implementing one or more embodiments for a multi-chiplet TEE and like aspects disclosed herein. For instance, the components or sub-components described above may be embodied by the computing system 800, such as in the form of a computer or specialized electronic device that includes sufficient processing power, memory resources, and communications throughput capability to perform operations consistent with the examples herein.

The computing system 800 may include at least one hardware processing unit 802 such as a central processing unit (CPU), a graphics processing unit (GPU), a vector processing unit (VPU), a neural processing unit (NPU), a hardware accelerator, or combinations or variants thereof. The at least one hardware processing unit 802 is an implementation of processor circuitry and may be embodied by various types of chip assemblies, products, or packages as discussed with reference to FIGS. 6 to 7B. Circuitry (e.g., processing circuitry) as used herein is a collection of circuits implemented in tangible entities of the computing system 800 that include hardware (e.g., simple circuits, gates, logic, etc.). Circuitry membership may be flexible over time. Circuitries include members that may, alone or in combination, perform specified operations when operating. In some examples, hardware of the circuitry may be immutably designed to carry out a specific operation (e.g., hardwired).

In an example, the hardware of the circuitry may include variably connected physical components (e.g., execution units, transistors, simple circuits, etc.) including a machine-readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, the machine-readable medium elements can be part of the circuitry or communicatively coupled to the other components of the circuitry when the device is operating. Also, in some examples, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time.

The computing system 800 may also include at least one memory device 804 such as volatile memory 806 and non-volatile memory 808, and at least one storage device such as removable storage 810 and/or non-removable storage 812 such as a drive unit, some or all of which may communicate with each other via an interconnect, fabric, link, or bus 820.

The computing system 800 may include an output interface 816 such as an interface connected to a display device, and an input interface 814 such as an interface connected to an alphanumeric input device or a user interface (UI) navigation device. In some examples, a connected I/O device may also include a display device, alphanumeric input device, and navigation device that is integrated into a single unit such as a touch screen display.

The computing system 800 may additionally include a communication interface 818, such as for connection with a network interface device used to transmit and receive electronic signals on a network. The computing system 800 may also include other interfaces or hardware (not shown) in connection with a signal generation device (e.g., an audio or radio signal generation device), an output controller (e.g., for connection with a serial, universal serial bus (USB), parallel, or other wired or wireless connection such as which uses via infrared (IR) or near field communication (NFC) technologies), an input controller (e.g., for connection with sensors or peripheral devices), and the like.

Any of the memory or storage devices such as the volatile memory 806, the non-volatile memory 808, the removable storage 810, or the non-removable storage 812 may provide a machine-readable medium. Some examples of a machine-readable medium are a non-transitory medium that hosts or stores one or more sets of data structures or instructions (e.g., software instructions) embodying or utilized by any one or more of the techniques or functions described herein. Such instructions are collectively labeled as instructions 824 with respective implementations of instructions 824A, 824B, 824C, 824D, and 824E.

The instructions 824 may reside, during execution or other operation of the computing system 800, completely or at least partially within the volatile memory 806 as instructions 824B, within non-volatile memory 808 as instructions 824C, within removable storage as instructions 824D, within non-removable storage as instructions 824E, or within the hardware processing unit 802 as instructions 824A. Thus, any combination of the hardware processing unit 802, the volatile memory 806, the non-volatile memory 808, or a storage device of the removable storage 810 or non-removable storage 812 may constitute a machine-readable medium or media. The instructions 824A, when loaded and executed by the hardware processing unit 802, may invoke or utilize a defined instruction set 822 of the hardware processing unit 802, such as a processor instruction set defined by an instruction set architecture (ISA) of a reduced instruction set computer (RISC) or complex instruction set computer (CISC) architecture-including but not limited to the RISC-V Instruction Set provided in a RISC-V architecture. It will be understood that a RISC-V architecture and instruction set is one of several available architectures and instruction sets that may be used in implementations of the functional compute components (e.g., the hardware processing unit 802) discussed herein.

The term “machine readable medium” may include any medium that is capable of storing, encoding, or carrying instructions for execution by components or the whole of the computing system 800 (or a similar machine) and that cause the computing system 800 or its components to perform any one or more of the techniques or functions described herein, or that is capable of storing, encoding or carrying data structures used by or associated with such instructions. Non-limiting machine-readable medium examples may include solid-state memories, and optical and magnetic media. Specific examples of machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; and optical or magneto-optical disks.

The instructions 824 may further be transmitted or received over a communications network using a transmission medium via the communication interface 818 and related devices utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), and wireless data networks (e.g., Institute of Electrical and Electronics Engineers (IEEE) 802.11 family of standards known as Wi-Fi®), IEEE 802.15.4 family of standards, peer-to-peer (P2P) networks, among others.

Method examples or other operations described herein can be implemented in part or in whole by the aforementioned machines, platforms, or devices, or related systems (including computer, robotic, and autonomous systems). The components of the illustrative devices, systems, and methods employed may be implemented in various examples by digital electronic circuitry, analog electronic circuitry, or in computer hardware, firmware, software, or in combinations of them. These components may be implemented, for example, as a computing program product such as a computing program, program code or computer instructions tangibly embodied in an information carrier, or in a machine-readable storage device, for execution by, or to control the operation of, a data processing apparatus such as a programmable processor, a computer, or multiple computers.

A computing program may be written in any form of programming language, including compiled or interpreted languages, and it may be deployed in any form, including as a stand-alone program or as a module, component, subroutine, or other unit suitable for use in a computing environment. Also, functional programs, codes, and code segments for accomplishing the techniques described herein may be easily construed as within the scope of the present disclosure by programmers skilled in the art.

Method steps associated with the illustrative embodiments may be performed by processing circuitry executing a computing program, code, or instructions to perform operations or functions (e.g., by operating on input data and/or generating an output). Further, such operations or functions may be embodied by a machine-readable medium, which is capable of storing instructions for execution by processing circuitry (including the specific processing unit examples discussed herein), such that the instructions, when executed by the processing circuitry, cause the processing circuitry to perform any one or more of the methodologies described herein.

Additional examples of the presently described embodiments include the following, non-limiting implementations. Each of the following non-limiting examples may stand on its own or may be combined in any permutation or combination with any one or more of the other examples provided below or throughout the present disclosure.

As a summary of the present disclosure, unit (e.g., chiplet, accelerator, etc.) enhancements can include TEE or TEE-like structures to enable TEE operations within these units. In order to extend TEE domains, these unit specific TEE structures can accept and use TEE parameters (e.g., process ID enable lists, encryptions keys, etc.) from another unit such that processes running on any unit in the TEE domain share these same parameters. Thus, the TEE operational environment is essentially cloned across units and extends the TEE domain across discrete operational units of a package or even outside of the package.

These features enable inclusion of on-chip accelerators within trusted domains (e.g., for VMs) by defining resources within a component (e.g., an accelerators) as part of a TEE via spatial or temporal slicing. Thus, the components (e.g., accelerators or parts of accelerators) within the TEE can grow or shrink, over time, as defined by an inter-component definition procedure. This can be accomplished by including, in each TEE capable component, TEE circuitry configured to advertise TEE availability, and accept specifics (e.g., encryption keys) for a TEE domain via an inter-component signaling mechanism. Thus, an orchestrating device, such as a CPU, can establish a TEE domain and expand the elements within the TEE domain by sharing the domain specifics with other computing elements in within a computing device, such as chiplet-based processors, System-on-chip (SoC) circuitry, System-in-Package (SiP) or System-on-Package (SoP) circuitry, and other modular packaging implementations of processor circuitry. Additional details and examples are provided below.

Example 1 is a chiplet for a multi-chiplet trusted execution environment (TEE), the chiplet comprising: an interface configured to communicate with a second chiplet; and processing circuitry that, when in operation, is configured to: receive, via the interface, a signal indicating creation of a TEE domain at the second chiplet, the creation of the TEE domain based on a process of the second chiplet; obtain an identifier of the TEE domain based on the signal; receive, via the interface, a request for the TEE domain; verifying the request based on the identifier; and executing the request based on a successful verification of the request.

In Example 2, the subject matter of Example 1, wherein, to obtain the identifier, the processing circuitry is configured to: make a request for the identifier of the second chiplet in response to the signal; and receive the identifier as a response to the request.

In Example 3, the subject matter of any of Examples 1-2, wherein the identifier is a cryptographic element used to ensure execution isolation in a TEE of the second chiplet.

In Example 4, the subject matter of Example 3, wherein the cryptographic element is a signature.

In Example 5, the subject matter of any of Examples 3-4, wherein the cryptographic element is a decryption key.

In Example 6, the subject matter of Example 5, wherein the decryption key is a symmetric key.

In Example 7, the subject matter of any of Examples 1-6, wherein the chiplet includes a Resource Arbitration Login (RAL) component, and wherein, to verify the request based on the identifier, the processing circuitry is configured to use the RAL component.

In Example 8, the subject matter of Example 7, wherein the processing circuitry is configured to write a RAL local identifier to the RAL component based on the identifier in response to obtaining the identifier to create a RAL local identifier.

In Example 9, the subject matter of Example 8, wherein the processing circuitry is configured to: detect the identifier in the request; and verify the identifier in the request using the RAL local identifier.

In Example 10, the subject matter of any of Examples 1-9, wherein the chiplet includes a Trust Provisioning Agent (TPA) component, and wherein, to verify the request based on the identifier, the processing circuitry is configured to use the TPA component.

In Example 11, the subject matter of Example 10, wherein the processing circuitry is configured to write a TPA local identifier to the TPA component based on the identifier in response to obtaining the identifier to create a TPA local identifier.

In Example 12, the subject matter of Example 11, wherein the processing circuitry is configured to: detect the identifier in the request; and verify the identifier in the request using the TPA local identifier.

In Example 13, the subject matter of any of Examples 1-12, wherein the identifier is a base memory address of the process on the second chiplet.

In Example 14, the subject matter of Example 13, wherein the chiplet includes a Memory Management Unit (MMU) component, and wherein, to verify the request based on the identifier, the processing circuitry is configured to use the MMU component.

In Example 15, the subject matter of Example 14, wherein the processing circuitry is configured to write the base memory address to the MMU for the process.

In Example 16, the subject matter of any of Examples 1-15, wherein the chiplet includes a set of components including at least one component, and wherein, to execute the request, the processing circuitry is configured to use the set of components.

In Example 17, the subject matter of Example 16, wherein the set of components are defined by the second chiplet.

In Example 18, the subject matter of any of Examples 16-17, wherein the set of components are defined based on time.

In Example 19, the subject matter of any of Examples 16-18, wherein the processing circuitry is configured to prevent operations from other domains on the set of components.

In Example 20, the subject matter of any of Examples 16-19, wherein the set of components include a memory device, an accelerator, a processor, or an interface.

In Example 21, the subject matter of any of Examples 1-20, wherein the processing circuitry is configured to: receive, via the interface, an attestation query from the second chiplet; and respond, via the interface, to the attestation query with an attestation metric.

In Example 22, the subject matter of Example 21, wherein the second chiplet provides the attestation metric received from the chiplet to an external attestation entity to verify the chiplet.

Example 23 is a method for a multi-chiplet trusted execution environment (TEE), the method comprising: receiving, at processing circuitry of a first chiplet in a chiplet system, a signal indicating creation of a TEE domain at a second chiplet, the creation of the TEE domain based on a process of the second chiplet; obtaining an identifier of the TEE domain based on the signal; receiving a request for the TEE domain; verifying the request based on the identifier; and executing the request based on a successful verification of the request.

In Example 24, the subject matter of Example 23, wherein obtaining the identifier includes: making a request for the identifier of the second chiplet in response to the signal; and receiving the identifier as a response to the request.

In Example 25, the subject matter of any of Examples 23-24, wherein the identifier is a cryptographic element used to ensure execution isolation in a TEE of the second chiplet.

In Example 26, the subject matter of Example 25, wherein the cryptographic element is a signature.

In Example 27, the subject matter of any of Examples 25-26, wherein the cryptographic element is a decryption key.

In Example 28, the subject matter of Example 27, wherein the decryption key is a symmetric key.

In Example 29, the subject matter of any of Examples 23-28, wherein verifying the request based on the identifier includes using a Resource Arbitration Login (RAL) component of the first chiplet.

In Example 30, the subject matter of Example 29, comprising writing a RAL local identifier to the RAL component based on the identifier in response to obtaining the identifier to create a RAL local identifier.

In Example 31, the subject matter of Example 30, comprising: detecting the identifier in the request; and verifying the identifier in the request using the RAL component local identifier.

In Example 32, the subject matter of any of Examples 23-31, wherein verifying the request based on the identifier includes using a Trust Provisioning Agent (TPA) component of the first chiplet.

In Example 33, the subject matter of Example 32, comprising writing a TPA local identifier to the TPA component based on the identifier in response to obtaining the identifier to create a TPA local identifier.

In Example 34, the subject matter of Example 33, comprising: detecting the identifier in the request; and verifying the identifier in the request using the TPA local identifier.

In Example 35, the subject matter of any of Examples 23-34, wherein the identifier is a base memory address of the process on the second chiplet.

In Example 36, the subject matter of Example 35, wherein verifying the request based on the identifier includes using a Memory Management Unit (MMU) component of the first chiplet.

In Example 37, the subject matter of Example 36, comprising writing the base memory address to the MMU component for the process.

In Example 38, the subject matter of any of Examples 23-37, wherein executing the request includes using a set of components of the first chiplet.

In Example 39, the subject matter of Example 38, wherein the set of components are defined by the second chiplet.

In Example 40, the subject matter of any of Examples 38-39, wherein the set of components are defined based on time.

In Example 41, the subject matter of any of Examples 38-40, wherein the first chiplet prevents operations from other domains on the set of components.

In Example 42, the subject matter of any of Examples 38-41, wherein the set of components include a memory device, an accelerator, a processor, or an interface.

In Example 43, the subject matter of any of Examples 23-42, comprising: receiving an attestation query from the second chiplet; and responding, via the processing circuitry, to the attestation query with an attestation metric.

In Example 44, the subject matter of Example 43, wherein the second chiplet provides the attestation metric received from the first chiplet to an external attestation entity to verify the first chiplet.

Example 45 is a system comprising means to perform any method of Example 23-44.

Example 46 is machine readable media including instructions that, when executed by processing circuitry, cause the processing circuitry to perform any method of Examples 23-44.

Example 47 is a machine readable media including instructions that, when executed by processing circuitry of a first chiplet in a chiplet system, cause the processing circuitry to perform operations comprising: receiving a signal indicating creation of a Trusted Execution Environment (TEE) domain at a second chiplet, the creation of the TEE domain based on a process of the second chiplet; obtaining an identifier of the TEE domain based on the signal; receiving a request for the TEE domain; verifying the request based on the identifier; and executing the request based on a successful verification of the request.

In Example 48, the subject matter of Example 47, wherein obtaining the identifier includes: making a request for the identifier of the second chiplet in response to the signal; and receiving the identifier as a response to the request.

In Example 49, the subject matter of any of Examples 47-48, wherein the identifier is a cryptographic element used to ensure execution isolation in a TEE of the second chiplet.

In Example 50, the subject matter of Example 49, wherein the cryptographic element is a signature.

In Example 51, the subject matter of any of Examples 49-50, wherein the cryptographic element is a decryption key.

In Example 52, the subject matter of Example 51, wherein the decryption key is a symmetric key.

In Example 53, the subject matter of any of Examples 47-52, wherein verifying the request based on the identifier includes using a Resource Arbitration Login (RAL) component of the first chiplet.

In Example 54, the subject matter of Example 53, comprising writing a RAL local identifier to the RAL component based on the identifier in response to obtaining the identifier to create a RAL local identifier.

In Example 55, the subject matter of Example 54, wherein the operations comprise: detecting the identifier in the request; and verifying the identifier in the request using the RAL component local identifier.

In Example 56, the subject matter of any of Examples 47-55, wherein verifying the request based on the identifier includes using a Trust Provisioning Agent (TPA) component of the first chiplet.

In Example 57, the subject matter of Example 56, wherein the operations comprise writing a TPA local identifier to the TPA component based on the identifier in response to obtaining the identifier to create a TPA local identifier.

In Example 58, the subject matter of Example 57, wherein the operations comprise: detecting the identifier in the request; and verifying the identifier in the request using the TPA local identifier.

In Example 59, the subject matter of any of Examples 47-58, wherein the identifier is a base memory address of the process on the second chiplet.

In Example 60, the subject matter of Example 59, wherein verifying the request based on the identifier includes using a Memory Management Unit (MMU) component of the first chiplet.

In Example 61, the subject matter of Example 60, wherein the operations comprise writing the base memory address to the MMU component for the process.

In Example 62, the subject matter of any of Examples 47-61, wherein executing the request includes using a set of components of the first chiplet.

In Example 63, the subject matter of Example 62, wherein the set of components are defined by the second chiplet.

In Example 64, the subject matter of any of Examples 62-63, wherein the set of components are defined based on time.

In Example 65, the subject matter of any of Examples 62-64, wherein the first chiplet prevents operations from other domains on the set of components.

In Example 66, the subject matter of any of Examples 62-65, wherein the set of components include a memory device, an accelerator, a processor, or an interface.

In Example 67, the subject matter of any of Examples 47-66, wherein the operations comprise: receiving an attestation query from the second chiplet; and responding, via the processing circuitry, to the attestation query with an attestation metric.

In Example 68, the subject matter of Example 67, wherein the second chiplet provides the attestation metric received from the first chiplet to an external attestation entity to verify the first chiplet.

Example 69 is a system for a multi-chiplet trusted execution environment (TEE), the system comprising: means for receiving, at a first chiplet in a chiplet system, a signal indicating creation of a TEE domain at a second chiplet, the creation of the TEE domain based on a process of the second chiplet; means for obtaining an identifier of the TEE domain based on the signal; means for receiving a request for the TEE domain; means for verifying the request based on the identifier; and means for executing the request based on a successful verification of the request.

In Example 70, the subject matter of Example 69, wherein the means for obtaining the identifier include: means for making a request for the identifier of the second chiplet in response to the signal; and means for receiving the identifier as a response to the request.

In Example 71, the subject matter of any of Examples 69-70, wherein the identifier is a cryptographic element used to ensure execution isolation in a TEE of the second chiplet.

In Example 72, the subject matter of Example 71, wherein the cryptographic element is a signature.

In Example 73, the subject matter of any of Examples 71-72, wherein the cryptographic element is a decryption key.

In Example 74, the subject matter of Example 73, wherein the decryption key is a symmetric key.

In Example 75, the subject matter of any of Examples 69-74, wherein the means for verifying the request based on the identifier include means for using a Resource Arbitration Login (RAL) component of the first chiplet.

In Example 76, the subject matter of Example 75, comprising means for writing a RAL local identifier to the RAL component based on the identifier in response to obtaining the identifier to create a RAL local identifier.

In Example 77, the subject matter of Example 76, comprising: means for detecting the identifier in the request; and means for verifying the identifier in the request using the RAL local identifier.

In Example 78, the subject matter of any of Examples 69-77, wherein the means for verifying the request based on the identifier include means for using a Trust Provisioning Agent (TPA) component of the first chiplet.

In Example 79, the subject matter of Example 78, comprising means for writing a TPA local identifier to the TPA component based on the identifier in response to obtaining the identifier to create a TPA local identifier.

In Example 80, the subject matter of Example 79, comprising: means for detecting the identifier in the request; and means for verifying the identifier in the request using the TPA local identifier.

In Example 81, the subject matter of any of Examples 69-80, wherein the identifier is a base memory address of the process on the second chiplet.

In Example 82, the subject matter of Example 81, wherein the means for verifying the request based on the identifier include means for using a Memory Management Unit (MMU) component of the first chiplet.

In Example 83, the subject matter of Example 82, comprising means for writing the base memory address to the MMU component for the process.

In Example 84, the subject matter of any of Examples 69-83, wherein the means for executing the request include means for using a set of components of the first chiplet.

In Example 85, the subject matter of Example 84, wherein the set of components are defined by the second chiplet.

In Example 86, the subject matter of any of Examples 84-85, wherein the set of components are defined based on time.

In Example 87, the subject matter of any of Examples 84-86, wherein the first chiplet prevents operations from other domains on the set of components.

In Example 88, the subject matter of any of Examples 84-87, wherein the set of components include a memory device, an accelerator, a processor, or an interface.

In Example 89, the subject matter of any of Examples 69-88, comprising: means for receiving an attestation query from the second chiplet; and means for responding to the attestation query with an attestation metric.

In Example 90, the subject matter of Example 89, wherein the second chiplet provides the attestation metric received from the first chiplet to an external attestation entity to verify the second chiplet.

Example 91 is at least one machine-readable medium including instructions that, when executed by processing circuitry, cause the processing circuitry to perform operations to implement of any of Examples 1-90.

Example 92 is an apparatus comprising means to implement of any of Examples 1-90.

Example 93 is a system to implement of any of Examples 1-90.

Example 94 is a method to implement of any of Examples 1-90.

What is claimed is:

1. A chiplet for a multi-chiplet trusted execution environment (TEE), the chiplet comprising:
an interface to communicate with a second chiplet; and
processing circuitry that, when in operation, is to:
receive, via the interface, a signal indicating creation of a TEE domain at the second chiplet, the creation of the TEE domain based on a process of the second chiplet;
obtain an identifier of the TEE domain based on the signal;
receive, via the interface, a request including an operation on the TEE domain;
verifying the request based on the identifier; and
executing the request based on a successful verification of the request.

2. The chiplet of claim 1, wherein, to obtain the identifier, the processing circuitry is to:
make a request for the identifier of the second chiplet in response to the signal; and
receive the identifier as a response to the request.

3. The chiplet of claim 1, wherein the identifier is a cryptographic element used to ensure execution isolation in a TEE of the second chiplet.

4. The chiplet of claim 1, wherein the chiplet includes a Resource Arbitration Login (RAL) component, and wherein, to verify the request based on the identifier, the processing circuitry is to use the RAL component.

5. The chiplet of claim 4, wherein the processing circuitry is to write a RAL local identifier to the RAL component based on the identifier in response to obtaining the identifier to create a RAL local identifier.

6. The chiplet of claim 1, wherein the chiplet includes a Trust Provisioning Agent (TPA) component, and wherein, to verify the request based on the identifier, the processing circuitry is to use the TPA component.

7. The chiplet of claim 6, wherein the processing circuitry is to write a TPA local identifier to the TPA component based on the identifier in response to obtaining the identifier to create a TPA local identifier.

8. The chiplet of claim 1, wherein the identifier is a base memory address of the process on the second chiplet.

9. The chiplet of claim 1, wherein the chiplet includes a set of components including at least one component, and wherein, to execute the request, the processing circuitry is to use the set of components.

10. The chiplet of claim 9, wherein the processing circuitry is to prevent operations from other domains on the set of components.

11. A non-transitory machine readable media including instructions that, when executed by processing circuitry of a first chiplet in a chiplet system, cause the processing circuitry to perform operations comprising:
receiving a signal indicating creation of a Trusted Execution Environment (TEE) domain at a second chiplet, the creation of the TEE domain based on a process of the second chiplet;
obtaining an identifier of the TEE domain based on the signal;
receiving a request for the TEE domain;
verifying the request based on the identifier; and
executing the request based on a successful verification of the request.

12. The non-transitory machine readable media of claim 11, wherein obtaining the identifier includes:
making a request for the identifier of the second chiplet in response to the signal; and
receiving the identifier as a response to the request.

13. The non-transitory machine readable media of claim 11, wherein the identifier is a cryptographic element used to ensure execution isolation in a TEE of the second chiplet.

14. The non-transitory machine readable media of claim 11, wherein verifying the request based on the identifier includes using a Resource Arbitration Login (RAL) component of the first chiplet.

15. The non-transitory machine readable media of claim 14, including writing a RAL local identifier to the RAL component based on the identifier in response to obtaining the identifier to create a RAL local identifier.

16. The non-transitory machine readable media of claim 11, wherein verifying the request based on the identifier includes using a Trust Provisioning Agent (TPA) component of the first chiplet.

17. The non-transitory machine readable media of claim 16, wherein the operations include writing a TPA local identifier to the TPA component based on the identifier in response to obtaining the identifier to create a TPA local identifier.

18. The non-transitory machine readable media of claim 11, wherein the identifier is a base memory address of the process on the second chiplet.

19. The non-transitory machine readable media of claim 11, wherein executing the request includes use of a set of components of the first chiplet.

20. The non-transitory machine readable media of claim 19, wherein the first chiplet prevents operations from other domains on the set of components.
